(19) United States
(12) Patent Application Publication
(10) Pub. No.: US 2002/0010757 A1
(43) Pub. Date: Jan. 24, 2002

(54) Method and apparatus for replacement of on-line advertisements

(76) Inventors: Joel Granik, Far Rockaway, NY (US); Frank Watervoort, Littleton, CO (US); Raphael Meyers, Long Beach, NY (US)

Correspondence Address: SCULLY SCOTT MURPHY & PRESSER, 400 Garden City Plaza, Garden City, NY, 11530, US

(21) Appl. No.: 09/728,307

(22) Filed: Dec. 1, 2000

Related U.S. Application Data
(60) Provisional application No. 60/168,877, filed on Dec. 3, 1999.

(51) Int. Cl. G06F 15/16

(52) U.S. Cl. 709/218; 709/245

(57) ABSTRACT

An Internet/world-wide-web-based advertisement replacement system and methodology for replacing advertising content on web-based communications received by users. The system comprises a web-browser device on a computer terminal for receiving the web-based communications having original advertising content including a target uniform resource locator (URL); a filter mechanism for identifying the original advertising content provided in the web-based communication; and, a mechanism for replacing original content with new advertising content for display at the computer terminal, the new advertising content determined based on a user profile information maintained by the system and including URL content for enabling user access to a destination web-site affiliated with advertisers providing the new advertising content.

### CROSS-REFERENCE TO RELATED APPLICATIONS

This application claims the benefit of provisional U.S. patent application Ser. No. 60/168,877 filed Dec. 3, 1999.

### BACKGROUND OF THE INVENTION

Web surfers (referred to as “web users” hereafter) have a conflicting relationship with online advertisers, i.e., advertisers who advertise via web/Internet-based communications. On the one hand, many web users are resistant to viewing additional advertisements, even if they are offered free services. Nonetheless, several companies offer free Internet access with the condition that while online a rotating advertisement box will appear on the web user's screen. Not surprisingly, most Internet users prefer to pay a monthly fee and avoid giving up screen space for advertisements.

On the other hand, there are products called “ad filters” which identify on which parts of the web page advertisements appear. These “ad filters” block unwanted advertisements from appearing on the web user's screen.

It would be highly desirable to provide a system and method implemented as a software application that can be downloaded by users of popular Internet web browsers to enhance and personalize their web browsing experience by replacing undesirable advertising content with new advertising or data content.

It would be highly desirable to provide an ad replacement system and methodology implementable as a software application that installs itself as part of the web browser and functions to filter certain recognizable advertising content or other web page content on the screen and replace that certain web-based advertising with personalized and more appropriate advertising content.

It would be further highly desirable to provide an ad replacement system and method implemented as a software application that may be personalized in accordance with user profile information including personal preferences of the user, that user's web browser viewing habits, and web browser navigation data gathered by the system.

It would be highly desirable to provide a system and method implemented as a software application that can be downloaded by users of popular Internet web browsers that functions to replace advertisements of original undesired content with new advertisement content based on user profile information for presentment to the user and, that enables users to earn money based on user actions

It would be highly desirable to provide a system and method implemented as a software application that can be downloaded by users of popular Internet web browsers to enhance and personalize their web browsing experience by modifying received advertising content with other data content.

### SUMMARY OF THE INVENTION

It is an object of the present invention to provide a system and method implemented as a software application that can be downloaded by users of popular Internet web browsers to enhance and personalize their web browsing experience by replacing undesirable advertising content with new advertising or data content.

It is another object of the present invention to provide an ad replacement system and methodology implementable as a software application that installs itself as part of the web browser and functions to filter certain recognizable advertising content or other web-page content on the screen and replace that certain web-based advertising with personalized and more appropriate advertising content.

It is a further object of the present invention to provide an ad replacement system and method implemented as a software application that may be personalized in accordance with user profile information including personal preferences of the user, that user's web browser viewing habits, and web browser navigation data gathered by the system.

It is yet another object of the present invention to provide an ad replacement system and method implemented as a software application that can be downloaded by users of popular Internet web browsers to enhance and personalize their web browsing experience and earn money at the same time.

It is yet another object of the invention to provide a system and method implemented as a software application that can be downloaded by users of popular Internet web browsers to enhance and personalize their web browsing experience by modifying received advertising content with other data content.

According to the invention, there is provided an An Internet/world-wide-web-based advertisement replacement system and methodology for replacing advertising content on web-based communications received by users. The system comprises a web-browser device on a computer terminal for receiving the web-based communications having original advertising content including a target uniform resource locator (URL); a filter mechanism for identifying the original advertising content provided in the web-based communication; and, a mechanism for replacing original content with new advertising content for display at the computer terminal, the new advertising content determined based on a user profile information maintained by the system and including URL content for enabling user access to a destination web-site affiliated with advertisers providing the new advertising content. An incentive award is provided for compensating a user who views an ad impression, navigates, i.e., clicks-through to a web-site affiliated with the new advertising content when selected by the user, and/or conducts a transaction at the affiliated web-site.

### BRIEF DESCRIPTION OF THE DRAWINGS

Further features and advantages of the invention will become more readily apparent from a consideration of the following detailed description set forth with reference to the accompanying drawing, which specifies and shows preferred embodiments of the invention, and in which:

FIG. 1 is a diagram illustrating, at a high-level, the components that cooperate to support the Ad Replacer system and method of the invention.

### DETAILED DESCRIPTION OF THE INVENTION

The present invention is directed to an ad replacement system (referred to hereinafter as the “Ad Replacer”) that functions to identify one or more advertisements sent to a user agent, e.g., a web browser, and, using a filter (for example), replaces it (or them) with another one or more advertisements that a web “surfer” (user) is interested in viewing. The replaced advertisements are alternately referred to as “campaigns” and may run for a specific number of days in accordance with the advertiser's subscription. It should be understood that, rather than replacing the data with new advertising data, the advertising content may be replaced with other types of data/information. The ad replacement system may further function to modify existing content with new content, e.g., place a border around an advertisement or underline certain words.

Generally, the Ad Replacer is an application, e.g., written in Java™, that is downloaded by users of popular Internet web browsers as a browser plug-in to enhance and personalize their web browsing experience. The application installs itself as part of the web browser, functions to parse downloaded web-page code containing undesired advertisement content and filter out the undesired advertising content by preventing it from being displayed, and then replaces the filtered out web-based advertising with personalized and more appropriate content, i.e. other advertisements or information. As will be described in greater detail herein, the advertising content or information that is replaced by the client application may be based on user profile information including, but not limited to: personal preferences of the user, that user's web browser viewing habits, and, web browser navigation data as gathered by the system. Furthermore, the act of replacing an ad for user viewing, referred to herein as an “impression”, entitles the user to certain rewards based on their subscription. That is, each impression credited to a particular user is tracked in the system and logged so that a user may subsequently be recompensed. Furthermore, users performing certain pre-defined user actions, including but not limited to: generating “click-throughs” (indicating that the user not only saw the advertisement but additionally clicked on the campaign ad to go to the destination web site for that ad ) or, purchasing from a destination web site affiliated with the campaign, will additionally entitle users to rewards. These rewards may be monetary, e.g., a credits or checks payable to the user, or may comprise some other award or incentive, e.g., frequent flier miles or entry in a sweepstakes, etc. The degree of the monetary incentives may vary with the actions performed by the user, the advertising campaign, and with the level of tracking information (navigation) that the user wishes to disclose, which is determined by settings in a user profile.

According to another aspect of the invention, retailers and/or on-line advertisers may run an ad campaign for a prespecified time, e.g., a particular number of days, or for a specific number of impressions. Particularly, the advertisers will pay the owner or operator of the Ad Replacer for every impression (or perhaps for every advertisement clicked on by the web user) and the Ad Replacer system, in turn, will pass along a percentage of that revenue to the user. The Ad Replacer thus also includes a counter mechanism that keeps track of how many advertisements each web user has seen, and/or how many advertisements each viewer has clicked on, or whether that user purchased a product from or otherwise transacted with the destination web side. As will be described, a difference between the users of the Ad Replacer and the other web users is that users of the Ad Replacer may be actually paid for the use of the application by accumulating rewards for every ad that was viewed or clicked on.

Client Application

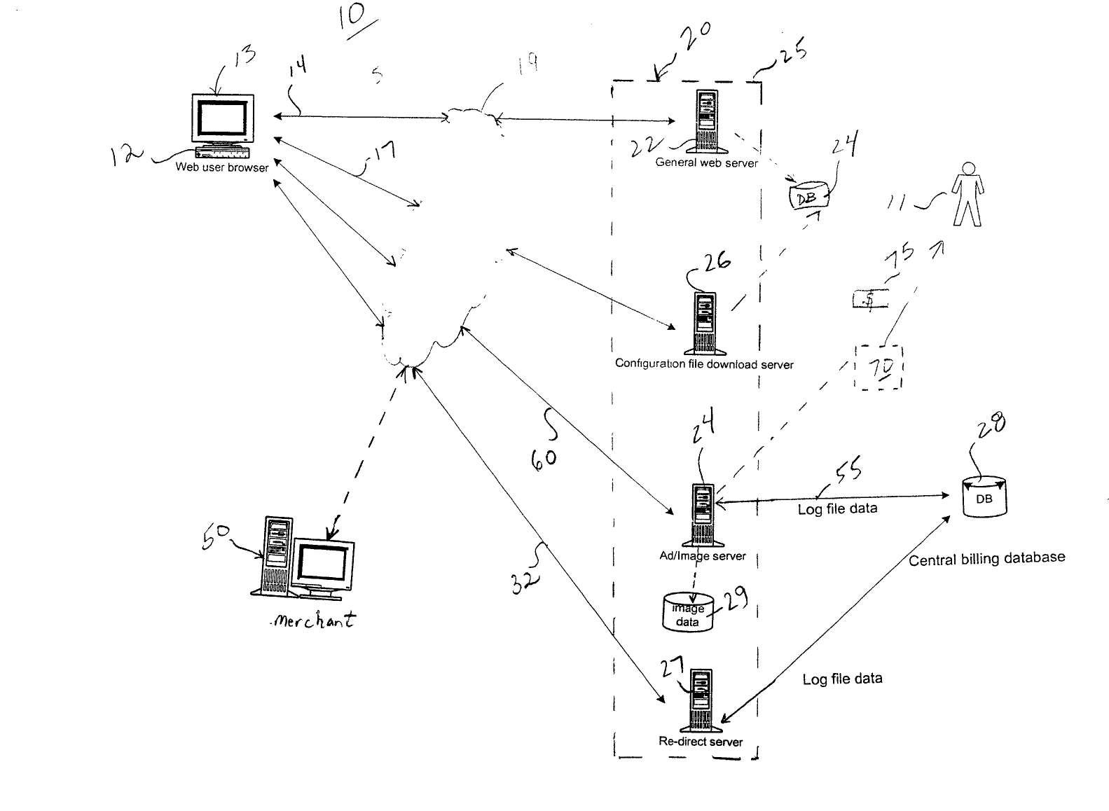

As shown in FIG. 1, the workhorse of the Ad Replacer system 10 is a client application 14 that is downloaded via the Internet 19, plugs into a user's web browser 12 at the user's computer terminal 13 or like computing device, and, acts as a local proxy server to the web browser. This proxy does not interfere with normal operation of the browser other than inspecting all downloaded content 15 and replacing ads based on pre-defined business rules. It is understood that the proxy approach enables platform independence and ensures that web users will only have to download one version of the Ad Replacer application, irrespective of the browser the user implements. It is understood however, that it is within the purview of skilled artisans to suitably configure the Ad Replacer application so that it may work with the specific type of browser platform implemented by the web user. Obviously, application configuration may differ based on the chosen browser platform, but preferably, is supported through automatic detection of the browser in use. Currently, major browsers such as Internet Explorer version 4.01 or higher Netscape Communicator version 4.0 or higher are supported, however, other browser platforms may be supported. According to the invention, the following components are installed on the web user's personal computer after sign-up and download of the Ad Replacer application to the user's computer: 1) an Installation Wizard that helps the user to set up the client application and can assist with troubleshooting if necessary; 2) a background application that filters and replaces content based on personal profile, target URL and keywords; 3) an Ad rotator that rotates the ads/images that are available for the different target URLs; 4) an uninstall utility in for the event the web user decides to remove the client application from his/her personal computer; and, 5) encrypted data configuration files containing information regarding the target content and the content that the target content is to be replaced with. These client application components will be described in greater detail herein.

FIG. 1 further illustrates, at a high-level, the components that cooperate to support the Ad Replacer application. It is understood that initial deployment of the Ad Replacer product may be accomplished using a limited number of physical servers. Thus, the servers shown and described with respect to FIG. I do not imply separate physical servers for every function. Several functional servers could be installed on one physical server until volumes warrant an expansion to a server cluster and therefore warrant functional separation. In a preferred embodiment, as illustrated in FIG. 1, via the Internet 19, web users may download the Ad Replacer application 14 from an Ad Replacer web site 20 implementing a general Ad Replacer server or server cluster 25. In a first step, at the Ad Replacer web site 20, the web user may set up an account and download an installation process that installs the client (Ad Replacer) application on the user's terminal 13. As part of this process, the user will be prompted for configuration information (e.g., target directory, etc.) after which the install will complete unattended in accordance with commonly known techniques. Release notes may be displayed upon installation or upgrade of the Ad Replacer application including information such as: 1) how to temporarily turn the application off; 2) how to un-install the Ad Replacer application and remove it from the system; 3) general troubleshooting tips; 4) presence of any new features; and 5) bug fixes, etc. As part of the installation, the user may additionally be prompted for security information including a unique id and/or password that may be used for subsequent user verification purposes. Specifically, the information to be verified is transmitted back to the Ad Replacer website 20 which retrieves a identifier/password by which the user may be recognized. If an existing user is re-installing the application, the application will verify that the user information that was entered is correct and will produce an error if the verification was unsuccessful (e.g. account expired, disabled, etc.). The installation process further checks for an existing version of Ad Replacer on the client machine and if an existing version is found, the user is prompted to select whether he/she wants to perform an upgrade of the current Ad Replacer application version. The upgrade must convert any existing configuration files to the newer version and prompt the user for any new additional configuration information that was not provided for the previous (older) version of Ad Replacer on the client.

More specifically, by clicking on an Ad Replacer client application download button via the website, the following installation process results: 1) the user may select ‘Open from the current location’ when prompted; 2) the installation will then determine whether Internet Explorer or Netscape Communicator browser has been installed in order to configure the Ad Replacer proxy correctly; 3) the installation process will enable the user to install the client application to a custom directory, or present a default option; 4) after completing the installation successfully, will download web user specific configuration files 17 including information about web pages having advertisements to be replaced and the target advertisement for replacement and verify the correctness of the files; and finally, 5) activate the Ad Replacer. As mentioned, the installation process will detect a previous installation of the Ad Replacer client and offer to upgrade if possible.

With specific regard to security, all pertinent traffic between the Ad Replacer application running on the client terminal 13 and the Ad Replacer server cluster 25 will be encrypted using 56-bit or higher public key encryption or proprietary encryption techniques, for example. Specifically, web users will enter a user ID and password to access their account on the Ad Replacer website. Users who forgot their password may click on a link that will send the password to their registered email address. Configuration files and other files containing data, e.g., data files including information regarding the target content and the content that the target content is to be replaced with, on the client machine, must be encrypted to prevent other parties from making changes to any data in any of the files. A checksum algorithm is preferably implemented to validate files upon download and ensure that files are not tampered with. Invalid files will render the Ad Replacer inactive and warn the web user that the current configuration files are not valid. Any information being sent to the Ad Replacer servers 25 must be authenticated by the servers in order to make sure that it was the Ad Replacer client application that originated the message and not a foreign application that is emulating the same type of traffic in order to boost e.g. advertising impressions, which would result in a fraudulent increase in rewards or incentives for the web user in question. Another way to prevent this is by limiting the incentives paid to one impression per campaign per pre-defined time period. Preferably, the Ad Replacer client application 14 is signed to an e-commerce provider of Internet-based trust services (not shown), including authentication, validation and payment needed by websites, such as VeriSign, in order to ensure to the user that the application is authentic and can be trusted when downloaded.

Background Application

As mentioned, the background application is a utility that filters and replaces content based on personal profile, target URL and keywords entered into the ‘search’ box of a pre-defined number of search engines. Specifically, the background application provides an automatic update function by looking out for new application updates and updating local configuration files on remote servers (automatic upgrades and configuration). This automatic update utility is activated every time the browser is opened or, at a predetermined regularly recurring time or event. Specifically, the background application will automatically connect to an update server or the configuration file download server 26 to determine whether there are any new files or updates that need to be downloaded. If there are no new files available, the utility will terminate immediately. The following files that may be downloaded automatically by the update utility include: 1) URL and ad/image ad database containing all replacement information regarding web pages on which ads/images will be replaced; 2) a new version of the Ad Replacer. The user will be prompted by the system if a new version is found and the user has the choice to either update the Ad Replacer client or not; 3) any other configuration files that the Ad Replacer client may need; and, 4) possibly download browsing habit information back to the server from the client if the web user gives permission.

General Web Server and Web user Account Servers

Providing access to Ad replacer web site 20 is the Ad Replacer server cluster 25 which includes a general web server 22 implemented for: 1) attracting new web users; 2) registering them to use the Ad Replacer; and, 3) providing users with general information, frequently asked questions and other relevant material. This web server 22 acts as the starting point for new users who wants to sign up to the Ad Replacer system. New web users are specifically asked to put together a profile with personal information prior to being able to download the Ad Replacer application. The personal information may comprise the following information: name; address; city; state; zip/postal code; country; telephone number; e-mail address; preferred method of reward payout (credit card, check, points, etc.); hobbies/interests (multiple selections from a list); gender; age; marital status; education; income; password for the account (+confirmation); and optionally, the user's browsing habits; Internet connection speed; hours of Internet/Web use per day; reasons for use, etc. As shown in FIG. 1, this user profile information may be stored in a user profile record located in a database 24 and accessible by the system for generating configuration files, determining ad rotation priorities, etc. This information is accessible by users as well and they may change their profile information at will. At sign-up, users may give permission for the Ad replacer system to track their web-browsing habits, i.e., track web-sites they have navigated to or visited. This information may further be used in determining a user profile for determining ad/image replacement content. Preferably, Web users will have on-line access to their personal user account on the Ad Replacer web site 20 via the Internet. After the user has logged on and has been authenticated, the user may invoke the following functions: 1) downloading the latest version of Ad Replacer; 2) changing their personal profile information, such as mailing address, hobbies/interests, account password, etc.; and, 3) view up-to-date statistics/balances on monetary rewards and/or incentives earned, paid out, etc.

Web user registration requires the user to designate a unique key by which a user is recognized when logging in. This key may comprise the user's email address. The Ad Replacer client will retrieve a system assigned identifier generated during the client application installation that will be associated with the user account from then on. The user will need to provide the user ID and password during installation in order for the client application to authenticate and configure the client correctly.

The general web server 22 additionally holds all the account balance information for every web user. The following list shows the items that may be displayed after a user has successfully created an account and has started using the Ad Replacer. The web user is allowed to view the following information for a predetermined past time period, e.g., the last 6 months: 1) accumulated credits; 2) paid credits; 3) unpaid credits; and 4) minimum threshold for credits to be paid out/awarded. The following further information may be displayed as well: 5) latest downloads, upgrades; and, 6) news and FAQ's; as well as functionality such as the ability to change personal information; and the ability to delete user account and all personal information.

Another function of the general web server 22 is to support merchants 50 that want to set up and track their own advertising campaigns. New merchants may sign up on-line but will not be able to schedule any advertising campaigns until the merchant has been approved and activated by appropriate Ad Replacer company personnel (not shown). The following information may be required during merchant account sign-up. Company name; Company primary industry sector; Company web site URL; Company Tax-ID; Billing address; Billing city; Billing state; Billing zip/postal code; Billing country; Billing contact name; Billing contact telephone number; Billing contact fax number; Billing contact email address; Primary contact name; Primary contact job title; Primary contact address; Primary contact city; Primary contact state; Primary contact zip/postal code; Primary contact country; Primary contact telephone number; Primary contact fax number; Primary contact email address; Technical contact name; Technical contact job title; Technical contact address; Technical contact city; Technical contact state; Technical contact zip/postal code; Technical contact telephone number; Technical contact fax number; Technical contact email address; and, Requested password (+confirmation). Merchants 50 particularly may log in to a secure area of the web site 20 and set up their own campaigns through an administrative interface. These campaigns may possibly be paid up-front by credit card (for package deals, like pre-defined number of impressions, etc.) and be activated immediately or be submitted ‘on-hold’ for quote and approval by appropriate Ad Replacer company personnel.

Merchants will additionally be able to view statistics for all advertising campaigns with a history that spans a pre-defined time span (e.g., previous 6 months). The following information will be displayed in a merchant statistics section of the site: campaign name (as assigned by merchant); current number of impressions; current number of click-throughs; maximum number of impressions (if available); maximum number of click-throughs (if available); banners/ads associated with the campaign; current charges for impressions and click-throughs; an analysis that correlates web user profile information with the number of impressions and click-throughs per campaign; and, any other information that may be obtained by correlating readily available information with the campaign statistics. Preferably, merchants 50 should be able to modify campaigns already in progress, such as, for example, changing ads/images on the fly (uploading to the Ad/Image server).

Configuration File Server

As shown in FIG. 1, the ad replacer cluster 25 further includes a local configuration file server 26 that serves application updates and new files with information about content that is to be replaced with other content. These files will be detected by the background application running on the client that keeps an eye open for new product updates, new configuration files, etc. and, are downloaded automatically.

The content replacement files are generated multiple times per week and may be distributed to specific groups of web users based on areas of interest that the web user indicated during sign-up. That is, not all content replacement information goes to all web users. As mentioned, web users will receive only specific targeted content replacement files that are generated based on their personal profile.

It should be understood that a separate update server (not shown) may be provided to serve up configuration file updates (with information regarding ads on web pages that are to be replaced), client application updates, etc. A small program checks availability of updates on the update server on a regular basis and downloads updates when they become available. Depending on the type of update, the user may be prompted (only in case of an application update) whether he/she would like to install the update.

Ad/Image Servers

As shown in FIG. 1, the image/ad servers 24 serve up the replacement content 60 to the web user's client browser 12 based on pre-defined rules. The web user's browser 12 will link directly to content located on the image server. When the browser 12 links to a specific piece of content on the image/ad server 24, an encrypted identifier is transmitted that identifies to the image/ad server 24 which web user's browser requested 12 the content, and thus, who should be credited with the impression. Each time a replacement ad/image is downloaded, the request is logged for that user so that he/she may be subsequently rewarded. A counter mechanism is provided that tallies all logged user impressions so that back-end processes may subsequently determine the appropriate rewards. Thus, by using this method, no action will be necessary on the client side to collect ad impression statistics, i.e., all statistics 55 are collected and generated by the image/ad server 24, and are particularly stored in a database 28. On a periodic basis, e.g., daily, a scheduled back-end process will scan image/ad server log files in database 28 for these identifiers and update web user account and advertising campaign statistics with their subsequent ad views. This approach of collecting statistics is very scalable in that it is very easy to extend the capacity of the statistics collection in case the volume grows exponentially because all that is necessary is to place more front-end servers in the cluster since the back-end applications scale very well.

Thus, according to the invention, the following components and data is stored on the Ad/image servers 24: 1) image database 29 with images of various sizes for all advertising campaigns; 2) gathering logic and database 28 for impressions and click-through statistics 55 for billing and statistical analysis functions including: a) automatically retiring banner ads that have reached the maximum number of impressions or click-throughs ; b) logging in each impression for each campaign and tallying the number of impressions for each user; and, c) generating billing information for non-prepaid banner ad campaigns, so that a bill may be generated for an ongoing campaign. It should be understood that besides locating the counter module on the ad/image server a counter may be implemented at the user's terminal for monitoring the number of blocked advertisements.

Further components and data stored on the Ad/image server 24 include: 3) authentication logic to ensure that any traffic originating from the Ad Replacer client is originated by the client and is not generated by a foreign application to emulate traffic to increase monetary incentives; 4) accompanying data for the images that constitute the necessary information to build a URL that the web user's browser is to be re-directed to when the images are clicked on; 5) upload and auto size capabilities to change image sizes dynamically upon upload; 6) automatic activation and expiration of images or banner ads based on one or more of the following: effective date & end date; effective date and maximum number of impressions; and, effective date and maximum number of click-throughs; 7) back-end scheduled processes with built in logic to keep track of impressions on images/banner ads and update that information in the user account; 8) back-end scheduled processes with built in logic to delete user accounts after a pre-defined amount of time of inactivity; and, 9) algorithms for calculating cost to vendor per impression or click-through for billing purposes; 10) reporting mechanisms to report on payable web users rewards; and, 11) an optional interface to a financial system 70 to generate payables (e.g., checks) for the payable web user rewards, as will be described in greater detail.

Other components and data stored on the Ad/image servers 24 include: 12) reports for statistical analysis of advertising campaigns for internal use; and 13) administrative screens that allow administrative personnel to: a) add/edit/manage banner ads and image campaign information such as: 1) images/banner ads in standard sizes including ability to automatically resize banner ads; 2) set up a campaign with a maximum number of impressions and/or click-throughs, after which the campaign will be retired, or allow for unlimited number of impressions and/or click-throughs if billing is to occur after the fact; 3) set up amounts to be paid for each impression and/or click-through if billing is after the fact; 4) select which URL categories or URL's the banner ad or image will be included in. This covers the affinity targeting at the same time, since the administrator has control over which URL's or URL categories the banner ads will be displayed on; 5) select which demographic information is to be utilized for determining which campaign will be shown to each web user. The demographic information to be selected from is as follows: gender; age; martial status; education; income; and, occupation; 6) select geographic target market, e.g., state, city: zip code, etc., for determining who is eligible for the campaign; and, 7) select areas of interest for determining who is eligible for the campaign. The areas of interest may be added and deleted in the administrative screens and may include those areas as defined during the user sign-up. Example areas of interest include, but are not limited to, sports; stocks; entertainment; home living; and health, etc.; b) activate and deactivate users and modify information in user accounts where necessary including the ability to: 1) allow for changes in personal information such as name, address, email, etc.; 2) change user balances in terms of click-throughs and impressions (both accrued and paid out impressions); and, 3) deactivate and re-activate user accounts in case of suspected fraud or abuse; c) set up global to parameters for: 1) user incentives per impression; 2) user incentives per disclosed URL; 3) user incentives per click-through; 4) user incentives per purchase at an affiliate; 5) maximum incentives for all of the above per pay period; 6) pay periods and associated maximum amounts and minimums for check eligibility.

Re-direct Server

As shown in FIG. 1, the ad replacer cluster 25 further includes a re-direct server 27 which functions to re-direct a user ad click to its final destination. That is, when a web user clicks on an ad replaced by the Ad Replacer software, a link will take the user to the re-direct server 27. Particularly, in response to a user click on a replaced ad, a web-based communication 32 is generated that includes a re-direct ad URL including: 1) an encrypted identifier that identifies the user on the re-direct server; and 2) an ultimate destination website code. The re-direct server 27 particularly parses the re-direct URL query string for the identifier and the ultimate destination website code and, by means of a database lookup, maps and transforms the code into a real URL to link the user to the destination website. Using a destination website code in the ad URL rather than using the absolute destination website URL is advantageous in that the destination website may be changed on the fly by making a change in the database rather than by having to send every web user new content replacement files. This feature is handy if a destination website is no longer available or, in the case of A/R (Accounts Receivable) problems with vendors who requested setup of an advertising campaign by using the Ad Replacer technology. It is understood that user requests in the form of click-throughs are tracked by back-end processes running in the re-direct servers 27. It should be understood that a mechanism is in place for tracking only first click-throughs to a destination web site. Thus, if a user clicks-through to a destination web-site, exits the site and then accesses it again by clicking-through, only one access will be credited for that customer. According to the invention, the following components and data is stored on the re-direct servers: 1) gathering logic and database 28 for click-through statistics 55 for billing and statistical analysis functions; 2) logging in each click-through for each campaign (e.g., one entry per URL followed by a count) and tallying the number of click-throughs for each user; and, 3) initiating retirement of campaign ads that have reached the maximum number of click throughs. It should be understood that this server may additionally log user requests in the form of actions such as purchasing products at the destination web-site or conducting transactions, e.g. logging in, signing up to receive a news-letter, etc.. Such actions will additionally be tracked, logged into a customer account in the log files database 28, and credited to each web user so that a further reward may be payable to the user.

Back-end Processes

In accordance with the invention, the back-end system comprises specialized engines, e.g., written in Visual Basic, at least one of which traverses the log files in the database 28 from the ad/image and re-direct servers and performs the following: 1) determines when a respective impression threshold and/or click threshold has been exceeded and take appropriate action; and, 2) updates the merchant account totals for the ad campaign and credits the correct user accounts with the impressions/click-throughs. Each impression and click-through is worth a certain reward value, e.g., an amount of money and the system determines the account balance based on the number of impressions and click throughs for each user. These processes are extended to user requests such as purchase actions or other transactions at the destination web-site. Thus, as shown in FIG. 1, to the benefit of the user, a monetary sum, e.g., in the form of a check 75, may be awarded to the user every pre-defined period if the user has accumulated an account balance above a pre-defined threshold. If a user's account reaches a certain threshold, the balance becomes payable. Periodically, a billing engine may run and generate checks 75 for those account balances that are payable and will update the user accounts to show the balance as being paid out. A check-printer 70 will generate the checks that will then be mailed out to the participating web users. Preferably, user accounts may automatically expire (including built up credits which have not been paid that are under the threshold) after a pre-defined period of not receiving any activity from the user, or in case the user decides to no longer be part of the Ad replacer program.

As mentioned, on-line advertisers pay the owner or operator of the Ad Replacer website owner for every advertisement seen by the web user (or for every advertisement clicked on by the web user) and the owner in turn will pass along a percentage of that revenue back to the user. The users of the Ad Replacer get the full web experience, as do other web users (i.e. non-users). Yet they do not view more or less on-line advertisements than the other web users (i.e. non-users) would. The difference between the users of the Ad Replacer and the other web users is that users of the Ad Replacer are actually paid for the use of the application by accumulating rewards for every ad that was viewed or clicked on. The Ad Replacer further includes a mechanism for identifying whether someone is using a program to have his computer view web pages when the user is not around, and not credit that user's account for those advertisements. The fact that the Ad Replacer owner cannot always identify such situations is a risk that the advertisers will have to take. (The fact that a web user may be using an ‘ad filter’ is a risk companies take when advertising on conventional web-sites.) To further reduce such fraudulent activities, the Ad Replacer owner may decide to divide the entire web users share of the revenue equally amongst all web users who have seen a minimum number of advertisements that month.

Ad Rotator

The Ad rotator is a mechanism that rotates the ads/images that are available for the different target URLs to be replaced. Multiple ads that are programmed to be replaced in the same target URL are presented in a round robin fashion. A priority factor determined at campaign setup gives some ads/images a higher number of impressions than others that are slated for the same target URL. The merchant has to pay more to get a higher priority. The popularity of the target website (where ads are to be replaced) also helps in determining the price of the campaign and their ad/image rotation priority. User profile information, e.g., user interests, or user web sites navigated to, may also be used in determining ad rotation priority.

Uninstall Utility

The uninstall utility is provided for the event the web user decides to remove the client application from his/her personal computer. The program files folder that holds the applications will contain the uninstall application. The uninstall application removes all traces of the Ad Replacer application (including configuration files, etc.) and restores the web browser to normal operation. If the user placed files into the Ad Replacer program directory that the uninstall application does not recognize, it will not remove the foreign files, nor the directory where the Ad Replacer application was installed.

It should be understood that the Ad Replacer system is adaptable for different types of media, e.g. advertising on television (TV). For example, a device such as a set-top box comprising the Ad replacer client application may recognize the broadcast or presentation of a particular undesired TV commercial and, in accordance with the invention, replace it with a different commercial. The viewer may then receive a percentage of the revenue the replacement commercial may generate. The set-top box would preferably include a central processor unit and a memory device such as a hard drive (e.g., replay TV) or may be connected to the company server via a high bandwidth (e.g., cable) connection. The set-top box would include a device connected with the TV that will detect when a commercial is being shown. Upon detection, the device will contact the replacement module, which may be located either locally on the user's memory device or on a remote server, and will send the replacement commercial for presentation on the TV screen. The ad replacer system will be especially advantageous for viewers who may watch television on his/her home computer, when technology permits.

While the invention has been particularly shown and described with respect to illustrative and preferred embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. An Internet/world-wide-web-based advertisement replacement system for replacing advertising content on web-based communications received by users, said system comprising:
web-browser device on a computer terminal for receiving said web-based communications having original advertising content including a target uniform resource locator (URL);
filter mechanism for identifying said original advertising content provided in said web-based communication;
mechanism for replacing original content with new advertising content for display at said computer terminal, said new advertising content determined based on a user profile information maintained by said system and including URL content for enabling user access to a destination web-site affiliated with advertisers providing said new advertising content.

2. The system as claimed in claim 1, wherein user viewing of a replaced advertising content comprises an impression, said system further including:
mechanism for identifying each web user viewing an impression; and,
mechanism for logging in all impressions associated with user navigations and counting a number of impressions for a user in a predetermined time interval.

3. The system as claimed in claim 2, further including mechanism for enabling user access to said affiliated web site in response to user click-through of said URL content.

4. The system as claimed in claim 3, wherein said URL content includes a first hyperlink for directing the user to a predetermined server location in response to selection of a replaced new advertising content, said server location implementing mechanism for re-directing said user to said affiliated web site via an ad target URL.

5. The system as claimed in claim 4, wherein said mechanism for enabling user access to said affiliated web site includes mechanism for identifying a requesting user, said server location further implementing mechanism for logging in user requests to access affiliated web-sites and counting a number of user click-throughs for accessing said web-sites in a predetermined time interval.

6. The system as claimed in claim 5, wherein said URL content includes a destination website code, said mechanism for re-directing including a mechanism for mapping said destination website code with said ad target URL of said affiliated web site.

7. The system as claimed in claim 6, wherein said server location further implements mechanism for logging in user requests comprising transactions conducted by said users at said affiliated web-sites and counting a number of user transactions at accessed web-sites in a predetermined time interval.

8. The system as claimed in claim 2, further including mechanism for compensating a user for each viewed impression.

9. The system as claimed in claim 7, further including mechanism for compensating a user for each user request.

10. The system as claimed in claim 8, wherein compensating said user occurs after a threshold number of impressions are logged.

11. The system as claimed in claim 9, wherein compensating said user occurs after a threshold number of user requests including said click-throughs and transactions conducted are logged.

12. The system as claimed in claim 1, further including mechanism for generating configuration files for download to said user terminal, said configuration files comprising an indication of original advertising content to be replaced and the new advertising content for use by said replacing mechanism.

13. The system as claimed in claim 7, wherein said identifying mechanism includes an encrypted identifier embedded in said URL content for enabling identification of said user when requesting access to said affiliated web site.

14. The system as claimed in claim 1, further comprising a mechanism for rotating the new advertising content that is to replace said original content.

15. The system as claimed in claim 14, wherein said new advertising content that is to be rotated for replacement of said original content is based on a predetermined priority factor.

16. The system as claimed in claim 1, wherein said profile information includes user preferences.

17. The system as claimed in claim 1, further including mechanism for tracking a user's web-site navigations, wherein said profile information includes history of user web-site navigations.

18. The system as claimed in claim 1, further including mechanism for determining size of said original content as presented in said web-based communication, and conforming the size of replacing new advertising content to said determined size.

19. A method for enhancing Internet/World-wide-web user browsing experience comprising:
receiving requests from advertisers to present new advertising content to be web-pages navigated to by user's via a user's web browser device and providing said new advertising content including URL content for enabling user access to a web-sites affiliated with said advertisers;
receiving requests from web users to indicate desire for viewing new advertising content according when navigating to certain web pages, said requests including user profile information;
replacing original advertising content included in a web-based communication navigated to by a user with said new advertising content, said replacing new content determined according to user profile information provided in received user requests;
for each user, tracking each of: the number of user impressions of said new advertising content, and user navigations to said affiliated web sites, and,
compensating a user when either said number of user impressions of said new advertising content, and user navigations to said affiliated web sites exceeds a threshold, wherein said web browsing experience is enhanced by presenting to users new advertising content associated with their preferences.

20. The method as claimed in claim 19, further including the steps of: tracking farther user transactions conducted at said affiliated web sites; and compensating a user when the number of user transactions conducted at said affiliated web sites exceeds a threshold.

21. The method as claimed in claim 20, wherein said URL content includes an embedded encrypted identifier, said tracking step including the step of identifying said user when viewing an impression requesting access to said affiliated web site.

22. The method as claimed in claim 20, wherein said received requests from advertisers and users are received by an ad replacer system, said system receiving payment from said advertisers for presenting new advertising content and storing said new advertising content according to an advertising campaign, and compensating said users in accordance with said advertising campaign.

23. An Internet/world-wide-web-based advertisement replacement methodology comprising the steps of:
a) receiving web-based communications via a web-browser device on a computer terminal, said web-based communications having original advertising content;
b) identifying said original advertising content provided in said web-based communication;
c) determining new data content to replace said original advertising content based on user profile information; and,
d) replacing said original content with said new content for presentation to said user at said computer terminal

24. The method as claimed in claim 23, wherein said new content comprises new advertisement content provided by an advertiser, said new advertisement content including uniform resource locator (URL) content for enabling user access to a destination web-site affiliated with advertisers.

25. The method as claimed in claim 24, wherein user viewing of a replaced new advertising content comprises an impression, said method further including the steps of:
identifying each web user viewing an impression; and,
logging in all impressions associated with user navigations and counting a number of impressions for a user in a predetermined time interval.

26. The method as claimed in claim 25, further including the step of: enabling user access to said affiliated web site in response to user navigation and click-through of said URL content.

27. The method as claimed in claim 26, wherein said URL content includes hyperlink to a predetermined server location, said step of enabling user access to said affiliated web-site includes the steps of:
directing the user to a predetermined server location in response to user click-through; and,
said server re-directing said user to said affiliated web site via an ad target URL.

28. The method as claimed in claim 27, wherein said step of enabling user access to said affiliated web site further includes the step of:
identifying a requesting user; and, logging in user requests comprising user click-throughs and counting a number of user click-throughs in a predetermined time interval.

29. The method as claimed in claim 28, wherein said URL content includes a destination website code, said mechanism for re-directing including a mechanism for mapping said destination website code with said ad target URL of said affiliated web site.

30. The method as claimed in claim 28, further including the step of:
logging in user requests comprising transactions conducted by said users at said affiliated web-sites and counting a number of user transactions at accessed web-sites in a predetermined time interval.

31. The method as claimed in claim 25, further including the step of compensating a user for each viewed impression

32. The method as claimed in claim 30, further including mechanism for compensating a user for each user request.

33. The method as claimed in claim 31, wherein compensating said user occurs after a threshold number of impressions are logged.

34. The method as claimed in claim 32, wherein compensating said user occurs after a threshold number of user requests including said click-throughs and user transactions are logged.

35. The method as claimed in claim 23, further including the step of: generating configuration files for download to said user terminal, said configuration files comprising an indication of original advertising content to be replaced and the new content.

36. The method as claimed in claim 30, wherein said identifying step includes: retrieving an encrypted identifier embedded in said URL content for enabling identification of said user when requesting access to said affiliated web site.

37. The method as claimed in claim 23, further comprising the step of: rotating the new content that is to replace said original content.

38. The method as claimed in claim 37, wherein said rotating new content for replacement of said original content is based on a predetermined priority factor.

39. The method as claimed in claim 23, wherein said profile information includes user preferences.

40. The method as claimed in claim 23, further including the step of: tracking a user's web-site navigations, wherein said profile information includes history of user web-site navigations.

41. The method as claimed in claim 23, further including the step of: determining a size of said original content as presented in said web-based communication, and conforming the size of replacing new content to said determined size.

42. An Internet/World-wide-web based advertisement replacement system for enhancing web-user experience comprising:
means enabling subscription of advertisers to said system, said advertisers providing new advertising content to a system server device for presentation at a user's web browser device; means enabling subscription of web users to said system server, said web users providing user profile information to said system indicating preferences for new advertising content;
a device for replacing original advertising content included in a downloaded web-based communication with new advertising content determined according to said user profile information and displaying said web-based communication via a user's web browser interface; and,
mechanism for compensating a user when said web user views a web page comprising said new advertising content, wherein said web browsing experience is enhanced by presenting to users new advertising content associated with their profile.

43. The system as claimed in claim 42, wherein said mechanism for compensating includes further compensating a user who navigates, via said web browser, to a web site affiliated with said advertiser by clicking-through and selecting said new advertising content

44. The system as claimed in claim 43, wherein said new advertising content includes an associated hyperlink for directing the user to a system server upon said selection of said hyperlink, said system further including mechanism for re-directing said user to said affiliated web site associated with a target URL.

45. The system as claimed in claim 44, further including mechanism for identifying a requesting user, said system server logging in user requests for each of: said impressions and click-throughs to an affiliated web-site.

46. The system as claimed in claim 45, further including mechanism for counting said impressions and click-throughs to an affiliated web-site performed for each user, and compensating said user when said number of impressions and click-throughs exceeds a predetermined threshold for a in a predetermined time period.

47. The system as claimed in claim 46, wherein compensating said user includes providing a monetary award to said user.
